(19) United States
(12) Patent Application Publication
(10) Pub. No.: US 2021/0356732 A1
(43) Pub. Date: Nov. 18, 2021

(54) AN ELECTROWETTING OPTICAL ELEMENT

(71) Applicant: MIORTECH HOLDING B.V., Eindhoven (NL)

(72) Inventor: Hermanus FEIL, VALKENSWAARD (NL)

(21) Appl. No.: 17/286,280

(22) PCT Filed: Oct. 16, 2019
(86) PCT No.: PCT/NL2019/050681

§ 371 Date: Apr. 16, 2021

(30) Foreign Application Priority Data
Oct. 17, 2018 (NL) 2021827
Feb. 21, 2019 (NL) 2022618

(51) Int. Cl. G02B 26/00

(52) U.S. Cl. CPC G02B 26/005

(57) ABSTRACT

An electrowetting optical element, a method of manufacturing and a display including the same. The element includes a containment space containing a polar liquid relative to a non-polar liquid, immiscible with each other, a first electrode layer stack defining a first enclosing surface of the space and including a substrate, a first electrode layer, and an insulating layer having a hydrophobic first interface layer with the space, a second electrode layer stack defining a second enclosing surface of the space and including a superstrate and a second electrode layer having a second interface layer with the space and one or more cell walls fixedly mounted on the second stack and extending toward the first stack, for defining sides of the space. An end face of the walls adjacent the first stack faces the first layer in a loose manner, the second stack includes a thin film transistor electrode layer, and the walls are composed of electrically insulating material.

### FIELD OF THE INVENTION

The present invention relates to electrowetting optical element, a method of manufacturing and a display comprising such elements.

### BACKGROUND

Electrowetting technology is based on modification of an energy balance between on one hand surface tension forces of liquids and wetting properties of a solid surface, and on the other hand electrostatic forces induced by an applied voltage over a capacitor arrangement comprising said boundary layer.

An electrowetting optical element, or electrowetting optical panel, further referred to as electrowetting element, according to the state of the art may from bottom to top be comprised of respectively an electrode layer stack comprising a substrate and a first electrode layer, an electrically insulating hydrophobic layer or an insulating layer having a hydrophobic surface on a side opposite to the other electrode layer, for interfacing to a polar liquid and a non-polar liquid immiscible with each other. The element may further comprise a second electrode layer stack, which is opposite to the above described electrode stack and comprising an second electrode layer which is electrically in contact with the polar liquid and a superstrate for supporting the electrode layer.

Cell walls attached to the second electrode layer stack and extending between one electrode layer stack and the other electrode layer stack, form a containment space between both electrode stacks and the cell walls. The cell walls thus form a barrier for the polar liquid between the electrowetting cell and adjacent electrowetting cells to keep the polar liquid from moving towards other cells. An electrowetting element can form a pixel if each cell has its own independent electrode. As such, an electrowetting element having cell walls and a containment space in between the walls can be defined as an electrowetting cell. Multiple cells can form one single pixel of a display. Usually a display consists of a high number of pixels and each pixel consists of either one single cell, but most often consists of a number of cells, e.g. 400 which results in a pixel with a size of approximately 1×1 cm.

A plurality of electrically controlled electrowetting elements can together form a display which can be used for displaying arbitrary images by appropriately controlling the electrowetting elements forming the display. Electrowetting elements can have arbitrary shapes determined by the shape of the electrodes, such that displays can be manufactured for specific purposes.

An electrowetting element is mainly transparent, except for the non-polar liquid in each of the cells formed by the cell walls. The non-polar liquid is often non-transparent or has a low optical transmission coefficient. The transmission coefficient of the non-polar liquid typically depends on the application of the electrowetting element. In a colour display, an electrowetting element comprising coloured non-polar liquids may be used.

The principles of operation of an electrowetting element are as follows. In an unpowered state, i.e. when no voltage is applied over the first and second electrode, the lowest energetic state of the system is where the non-polar liquid, e.g. an oily liquid, forms a boundary layer between the polar liquid, e.g. a water based liquid, and the hydrophobic surface of the insulating layer. This is because the polar liquid is repelled by the hydrophobic layer. The poor transmissibility of the non-polar liquid then forms an obstruction to light that penetrates the system.

When a voltage is applied over the electrodes, the lowest energetic state of the system becomes the situation wherein the (poorly conductive or insulating) non-polar liquid is pushed aside by the (conductive) polar liquid, and the polar liquid thereby being in direct contact with the insulating hydrophobic layer. Note that the voltage must be large enough for the electrostatic forces to overcome the repellent and surface tension forces that separate the polar liquid from the hydrophobic surface. In this situation, light that penetrates the system has rather unobstructed access to the insulating hydrophobic layer because of the well transmissibility of the polar liquid and the non-polar liquid being pushed aside. In the powered-up state, when voltage is applied over the electrodes, the electrowetting element is thus transmissive.

Electrowetting technology is suitable for a wide range of applications, such as but not limited to, outdoor digital screens which may be used as digital traffic signs, message centers, billboards, etc.

In conventional electrowetting displays each pixel is controlled or addressed separately or direct by an individual physical electrical contact track for each pixel. When the number of pixels rises, the number of electrical tracks as well and the combined area of the tracks is relatively large to the active switching area of the pixels. This may limit increase of the number of pixels per element and also have a negative impact on the brightness since less light may reflect back from the element.

### SUMMARY OF THE INVENTION

It is an object of the present invention to provide an electrowetting optical element in which at least some of the above mentioned drawbacks have been resolved.

It is another object of the present invention to provide an electrowetting optical element with improved contrast.

In accordance with a first aspect of the invention the above-mentioned object is achieved with an electrowetting optical element which comprises:
a containment space for containing a polar liquid relative to a non-polar liquid, wherein said polar liquid and said non-polar liquid being immiscible with each other;
a first electrode layer stack defining a first enclosing surface of said containment space, and comprising a substrate, a first electrode layer, and an insulating layer having a hydrophobic first interface layer with said containment space;
a second electrode layer stack defining a second enclosing surface of said containment space, and comprising a superstrate and a second electrode layer having a second interface layer with said containment space;
one or more cell walls, being fixedly mounted on said second electrode layer stack and extending towards said first electrode layer stack, for defining sides of said containment space, and wherein an end face of said one or more cell walls adjacent said first electrode layer stack faces said hydrophobic first interface layer in a loose manner; wherein said second electrode layer stack comprises a thin film transistor electrode layer, and wherein said one or more cell walls are comprised of an electrically insulating material.

As indicated, electrowetting optical elements are the key components of electrowetting displays. Such electrowetting displays are very beneficial for a broad scope of applications.

Use of thin film transistors in displays such as electrowetting displays is known. In such displays the thin film transistor is used as electrode as compared to conventional electrodes that comprise a passive layer of conducting material. Such use of a thin film transistor is beneficial, amongst other reasons due to the fact that advantageous thin film manufacturing techniques can be use. By replacing the passive electrode layer with an active thin film transistor electrode layer, the display can also benefit from advantages of active matrix addressing.

In these known displays, the thin film transistor is provided in the substrate layer, also known as the first electrode layer and located below the isolating and hydrophobic layer.

Applying the thin film transistor in the substrate or first electrode layer may have the disadvantage that it results in height differences in the isolating layer and hydrophobic layer, which will cause non-uniform electrical fields.

In a first aspect of the present disclosure, the thin film transistor is located in the second, superstrate, electrode layer stack in stead of the first, substrate, electrode layer stack.

This would normally not result in a working display since the electrode of the superstrate is in contact with the polar liquid in the containment space. The polar liquid will cause a electric short circuit between two adjacent electrodes, i.e. thin film transistors of two adjacent cells. However, due to the position of the cell walls that are fixedly mounted on the second, superstrate, electrode layer stack not only the containment spaces of two adjacent cells are spaced separated from each other, the electrode is interrupted as well. By providing cell walls that are comprises of electrically insulating material it is prevented that the short circuit occurs between the electrodes, i.e. the thin film transistors, of the two adjacent cells.

An electrowetting display with such electrowetting elements or cells will not only function and have the advantages of the use of a thin film transistor in general, but will also address the issues related to the use of thin film transistors in the substrate layer such as height differences as explained above.

In an example, the thin film transistor layer may be implemented as a thin flex substrate and/or a thin flex superstrate and can be made with layer thickness of approximately 25 μm. This will result in minimal overall thickness which will reduce or eliminated the parallax effect.

The thin film transistor layer may have a high optical transparency and a wide optical transmission of the sub/superstrate. Using a thin film transistor may have other benefits such as a lower processing complexity due to the low temperature processing and a reduced number of processing steps. Thin film transistors may also use less power, have low leakage and low “off” state current behavior.

Thin film transistor layers that are able to meet such requirements are organic and metal oxide thin film transistors. To this end, the substrate and/or the superstrate preferably comprise PolyEthylene Naphthalate, PEN, flex materials. Such PEN material, when compared to traditional Polyimide, such PEN flex material has an optical clear transparency, low temperature and low costs.

The pixels of the electrowetting display according to the invention are defined by containment spaces which comprise cell walls. In conventional electrowetting displays the cell wall is attached to the first electrode layer, i.e. the substrate layer. The cell walls of the electrowetting display according to the invention comprise an end face by which the walls are fixedly attached to the second electrode layer stack or superstrate and a free end face which is adjacent to the first electrode layer stack or substrate and preferably in a loose manner.

Loose manner is in accordance with the present description to be interpreted as faced towards and very closely to but not in direct contact with the first electrode stack layer. Preferably, the free end of a cell wall demonstrates a small slit between the cell wall and the first electrode stack layer.

The superstrate of each cell of the electrowetting display according to the invention comprises two control lines or tracks, one as a row select and the other as a column select. In an example, the row select or the N gate line is aligned to the horizontal wall of the cell, and the column select or M gate is aligned to the vertical wall of the cell. In or near the cross section of the N and M gate lines the active transistor is disposed.

By aligning the row and column gate lines with the cell walls, the total or resulting transmissive surface of the cell is improved as compared to having these gate lines positioned within the surface between the cell walls.

In an example, the electrically insulating material is comprised in an insulating surface layer of one or more cell walls. In another example, the one or more cell walls are comprised of a monolithic insulating material.

In order to minimize the chance of a voltage breakdown in the pixel, the cell walls are preferably electrically insulating. This can be achieved by applying a layer of insulating material over the cell walls, for example applied as a post processing step in the manufacturing process. This could also be achieved by constructing the cell walls from a monolithic insulating material.

In an example, the cell walls comprise a hydrophobic surface layer formed on the end face of the one or more cell walls adjacent the first electrode layer stack.

In an example, a slit is present between the end face of the one or more cell walls and the first electrode layer stack.

In an example, the thin film transistor electrode layer comprises at least one transistor layout per containment space.

In an example, the thin film transistor electrode layer comprises an indium tin oxide layer.

In an example, the second electrode layer is at least partially covered with an insulating layer for electrically insulating the thin film transistor electrode layer from the polar liquid and the non-polar liquid.

In a second aspect of the invention an electrowetting optical display is presented which comprises one or more electrowetting optical elements according to one or more of the previous descriptions.

In a third aspect of the invention a method of manufacturing an electrowetting optical display is presented which comprises the steps of:
providing a first electrode layer stack comprising a substrate, a first electrode layer, and an insulating layer having a hydrophobic surface layer;
providing a second electrode layer stack comprising a deposited thin film transistor layer;
attaching cell walls to the second electrode layer stack thereby forming a containment space defined at least by the second electrode layer stack and the cell wall;
filling the containment space with a polar liquid and a non-polar liquid, which polar liquid and non-polar liquid are immiscible with each other,
covering the containment space with the first electrode layer stack.

The invention will further be described with reference to the enclosed drawings wherein embodiments of the invention are illustrated, and wherein:

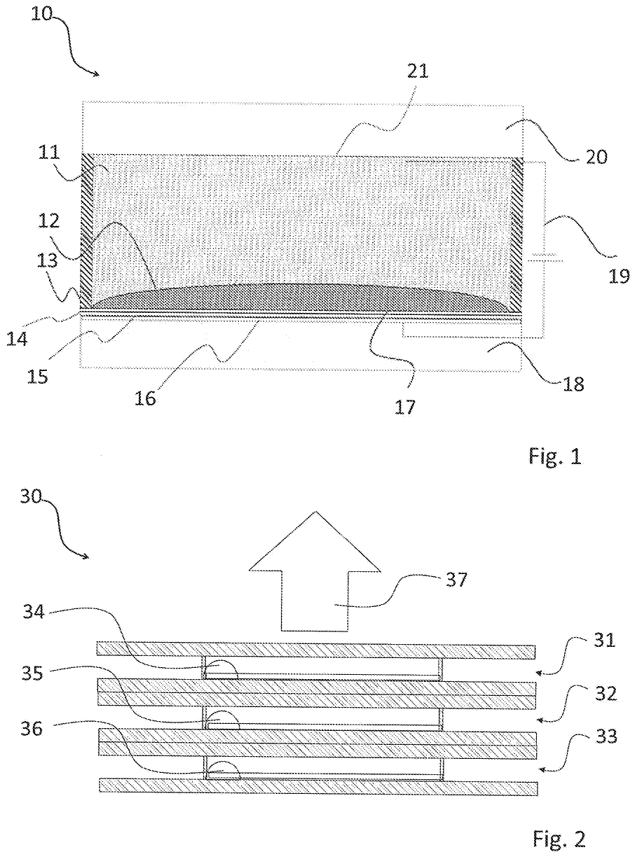

FIG. 1 shows in an illustrative manner, an electrowetting optical cell or pixel in accordance with an aspect of the invention;

FIG. 2 shows in an illustrative manner cross-sectional view of a cell of an electrowetting display with a three layered stack;

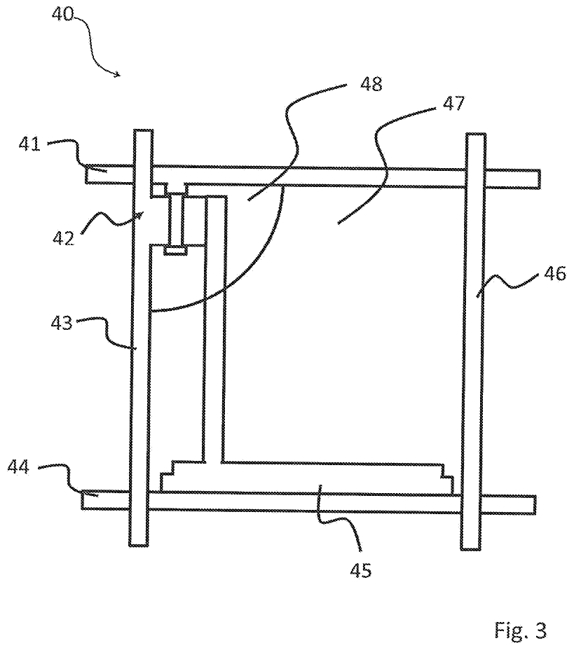

FIG. 3 shows in an illustrative manner an electrowetting optical cell or pixel with an active matrix TFT layer in accordance with an aspect of the invention.

FIG. 1 shows an electrowetting optical element or electrowetting element 10. In this figure only one single electrowetting optical element 10 is shown.

However, in a many electrowetting applications, such as digital traffic signs, message centers, full color billboards, wall scrapings, dynamic camouflage and other (outdoor) digital displays, the electrowetting display contains several of these elements 10.

Preferably, several cells form a tile which may be used to display a (single) character. A plurality of adjacent tiles may be contained in an electrowetting optical panel. The electronics to provide control and power to the device may be provided per panel, such that a panel can be operated separately. In most applications however the display may comprise several panels. The display, in case of multiple tiles and multiple panels, may comprise an optical wave guide to optically remove the visibility of the boundary of the element, i.e. the bezel or passive area of the individual electrowetting optical element.

The electrowetting element 10 of FIG. 1 consists of a containment space which is present between a two electrode layers 18, 20. The first electrode layer 18, seen from bottom to top, consists of a glass substrate 18. On top of the glass substrate is a transparent electrode(s) 16. The electrode is isolated from the other materials by an insulator layer 15 which covers the electrode(s) 16. The interface layer 14 is a layer with hydrophobic properties, such as a fluoropolymer. In order to improve the adhesion of the fluoropolymer to the insulator layer, the substrate may preferably also be provided with an adhesion promoting layer which is disposed between the fluoropolymer 14 and the insulator layer 15. Complete stack at the bottom of the pixel is also known as the substrate layer and defines a first enclosure surface of the containment space in which the two liquids 11, 12 are disposed.

The second stack is the superstrate or also known as the second electrode layer or second electrode layer stack. This second electrode layer defines a second enclosure surface of the containment space with the two liquids 11, 12. The second layer may also be constructed from a glass substrate 20 or also called superstrate. On top of the glass substrate a transparent electrode 21 is disposed, which is preferably formed of an electrically conducting material such as indium tin oxide (ITO) and preferably has a interface surface forming the interface with the containment space 25. As an alternative to ITO other transparent conducting materials may also be applicable. Also a conductive organic material known in the art having lower hydrophobic properties than the hydrophobic interface surface 14 of the first layer can be used.

The cell walls 13 are mounted on or attached to the second electrode layer stack 20 only and extend from this second electrode towards the first electrode interface layer 14. The cell walls 13 comprise small free end faces near the first interface layer 14. In between both a small slit may be present which is not shown in FIG. 1. This slit enables the non-polar liquid 12 to entrain the slits, and to form a small interface on the other side of the slit near the edge of the cell walls resulting from capillary action within the slit. An effect of the small capillary interface is that it greatly reduces the amount of light scattering caused by the cell walls 13 in the electrowetting optical cell from one electrode layer stack towards the other. The cell walls 13 thus form an effective barrier for the polar liquid 12 between the electrowetting cell and adjacent electrowetting cells to keep the non-polar liquid 12 from moving towards other cells. Although FIG. 1 may suggest a squire shaped pixel the electrowetting elements can have arbitrary shapes determined by the shape of the electrodes and cell walls, such that displays can be manufactured for specific purposes.

Together, the first and second electrode layer and the cell walls 13 allow the electrowetting element 10 to be powered on and off by applying an appropriate voltage 19 over the liquids. The superstrate layer 20 and substrate layer 18 may be formed by any suitable material but will often be formed by a transparent glass layer, and dependent on whether the electrowetting optical cell is of the transparent type or reflective type, the substrate layer may be formed by a non-transparent layer as well. Preferably, both the superstrate layer and substrate layer are formed from or flexible polymer material such as polyethersulfone (PES), polyimide (PI), polythiophene (PT), phenol novolac (PN), or polycarbonate (PC). Most preferably, the substrate and/or superstrate are formed from a polyethylene naphthalate or PEN. The PEN material is known to have very good barrier properties.

The layout of electrowetting element 40 with the thin film transistor is demonstrated in FIG. 3. The electrowetting element 40 is preferably comprised of a (flexible or rigid) thin film substrate transparent TFT and a thin film superstrate. The element is defined by the containment space in which the oil and water liquids are contained. This containment space has dimensions equal to the dimensions of the area formed by the two horizontal control lines 41, 44 and the two vertical control lines 43, 46. These control lines are preferably aligned with the cell walls such that no active area is lost. Since the cell walls of the electrowetting element extend between the two substrates, it is proposed to manufacture these walls from an electrically insulating material or provide them with such a coating or added layer. This way a voltage breakdown between the control lines, the transistor and the electrodes may be prevented or at least limited.

The pixel or cell can be activated through control of the horizontal and vertical control lines 41, 44, 43, 46. These vertical control lines may also be defined as source lines M 43 and the subsequent source line M+1 46. The horizontal control lines may also be defined as the gate line M 41 and the subsequent gate line M+1 44. In the intersection of the source line 41 and gate line 43 the switch element or active semiconductor, i.e. the transistor 42 is disposed. The transistor is connected to the source line 41, the gate line 43 and a transparent connection 45.

The pixel consists of a transparent electrode area 47 and an electrode-free area 48. The latter being located above or near the transistor 42. When the pixel is activated, the oil moves to the electrode-free area 48 such that the transistor will not decrease the transmissive area of the pixel.

As will be appreciated by the person skilled in the art, the present invention may be practiced otherwise than as specifically described herein. Obvious modifications to the embodiments disclosed, and specific design choices, will be apparent to the skilled reader. The scope of the invention is only defined by the appended claims.

1-9. (canceled)

10. An electrowetting optical element, comprising:
a containment space for containing a polar liquid relative to a non-polar liquid, wherein the polar liquid and the non-polar liquid are immiscible with each other;
a first electrode layer stack defining a first enclosing surface of the containment space, and comprising a substrate, a first electrode layer, and an insulating layer having a hydrophobic first interface layer with the containment space;
a second electrode layer stack defining a second enclosing surface of the containment space, and comprising a superstrate and a second electrode layer having a second interface layer with the containment space; and
one or more cell walls, fixedly mounted on the second electrode layer stack and extending towards the first electrode layer stack, defining sides of the containment space;
wherein an end face of the one or more cell walls adjacent the first electrode layer stack faces the hydrophobic first interface layer in a loose manner;
wherein the second electrode layer stack comprises a thin film transistor electrode layer; and
wherein the one or more cell walls are comprised of an electrically insulating material.

11. The electrowetting optical element according to claim 10, wherein the electrically insulating material is comprised in an insulating surface layer of the one or more cell walls.

12. The electrowetting optical element according to claim 10, wherein the one or more cell walls are comprised of a monolithic insulating material.

13. The electrowetting optical element according to claim 10, wherein the one or more cell walls comprise a hydrophobic surface layer formed on the end face of the one or more cell walls adjacent the first electrode layer stack.

14. The electrowetting optical element according to claim 10, wherein a slit is provided between the end face of the one or more cell walls and the first electrode layer stack.

15. The electrowetting optical element according to claim 10, wherein the thin film transistor electrode layer comprises at least one transistor layout per containment space.

16. The electrowetting optical element according to claim 10, wherein the thin film transistor electrode layer comprises an indium tin oxide layer.

17. An electrowetting optical display comprising one or more electrowetting optical elements according to claim 10.

18. A method of manufacturing an electrowetting optical display, comprising the steps of:
providing a first electrode layer stack comprising a substrate, a first electrode layer, and an insulating layer having a hydrophobic surface layer;
providing a second electrode layer stack comprising a deposited thin film transistor layer;
attaching cell walls to the second electrode layer stack to form a containment space defined at least by the second electrode layer stack and the cell walls;
filling the containment space with a polar liquid and a non-polar liquid, wherein the polar liquid and the non-polar liquid are immiscible with each other; and
covering the containment space with the first electrode layer stack.
